(19) United States
(12) Patent Application Publication
(10) Pub. No.: US 2011/0073061 A1
(43) Pub. Date: Mar. 31, 2011

(54) PISTONS WITH A ROUGH SURFACE

(76) Inventors: Jeungsuck Chae, Windsor (CA); Udo Rotmann, Marburg (DE); Wolfgang Rein, Milford, MI (US); Douglas Elliott, Saltillo (MX)

(21) Appl. No.: 12/879,444

(22) Filed: Sep. 10, 2010

Related U.S. Application Data
(60) Provisional application No. 61/246,250, filed on Sep. 28, 2009.

(51) Int. Cl. F02F 3/00

(52) U.S. Cl. 123/193.6

(57) ABSTRACT

A piston for an internal combustion engine including a piston crown having an upper surface and a lower surface; a piston skirt; and a generally cup-shaped undercrown formed on the lower surface of the piston crown and integral with the top portions of opposing side walls of the piston skirt, at least a portion of the surface of the undercrown being rough, defining at least one region of increased surface area, wherein the distance between an uppermost and lowermost points of the surface of the undercrown in the at least one region of increased surface area is in the range of approximately 0.1 mm to 1.0 mm.

### CROSS-REFERENCES TO RELATED APPLICATIONS

This application claims priority to U.S. Provisional Application No. 61/246,250, filed on Sep. 28, 2009, hereby incorporated herein by reference in its entirety.

### TECHNICAL FIELD

The present disclosure relates to a piston for an internal combustion engine having a rough interior surface.

### BACKGROUND

A piston assembly for an internal combustion engine generally becomes very hot during use and is subjected to relatively severe thermal stresses as compared to other engine components, especially on the top wall or crown portion of the piston, which is directly exposed to the heat of the gases in the combustion chamber that is partly defined by the piston. The issue of piston assembly crown temperature has become more of an issue with modern internal combustion engines, due to increases in thermal loading arising from increases in engine power output.

### BRIEF DESCRIPTION OF THE DRAWINGS

FIG. 1 is a partial cross sectional view of a piston including a piston skirt and a piston crown;

FIG. 2 is a bottom view of the interior of the piston of FIG. 1;

FIG. 3 is a cross sectional view of a portion of the undercrown of the piston of FIG. 1 including a region of increased surface area;

FIG. 4 is a top view of a casting tool used in forming the undercrown of FIG. 3;

FIG. 5 is a top view of the undercrown of the piston of FIG. 1 including a plurality of regions of increased surface area;

FIG. 6 is a top view of an alternate casting tool used in forming the plurality of regions of increased surface area of FIG. 5;

FIG. 7 is a process flow chart of an exemplary piston casting process;

FIG. 8 is a top view of an alternate illustration of the casting tool of FIG. 4;

FIG. 9A is a top view of the undercrown of the piston of FIG. 1 including an alternate region of increased surface area;

FIG. 9B is an enlarged view of the cross-hatching of FIG. 9A;

FIG. 10 is a top view of the interior of the piston including the undercrown of FIG. 9A, including the alternate region of increased surface area; and

FIG. 11 is a top view of a casting tool used in forming the region of increased surface area of FIG. 9A.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases, illustrative values of the constants are provided. In other cases, no specific values are given. The values of the constants will depend on characteristics of the associated hardware and the interrelationship of such characteristics with one another, as well as environmental conditions and the operational conditions associated with the disclosed system.

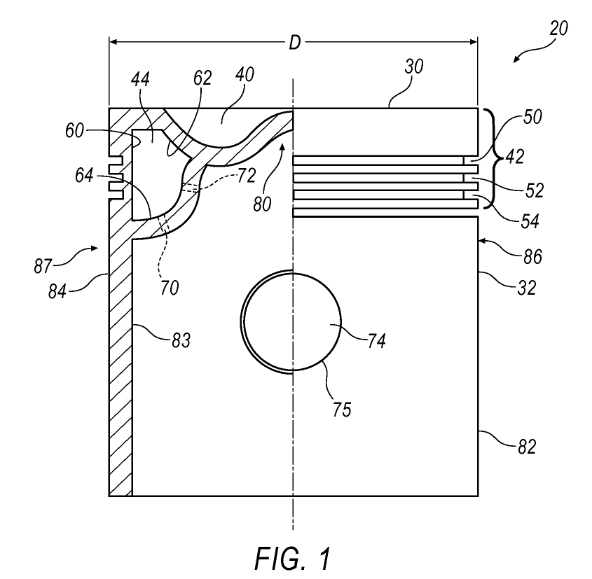

Turning now to the drawings and in particular to FIG. 1, an exemplary piston 20 for an internal combustion engine is disclosed. Piston 20 includes a piston crown 30 and a piston skirt 32. Piston crown 30 includes a combustion bowl 40 and a ring belt portion 42. Ring belt portion 42 includes a plurality of ring grooves 50, 52, 54 for receiving a plurality of piston rings (not shown). In particular, the ring belt portion 42 may include a first ring groove 50 closest to the piston crown 30, a second ring groove 52, and a third ring groove 54, the third ring groove spaced the furthest distance away from the piston crown. First ring groove 50 and second ring groove 52 may have compression rings (not shown) disposed therein, while the third ring groove 54 may have an oil control ring (not shown) disposed therein.

A cooling gallery 44 may be located within the piston 20, and may include a cooling gallery surface 60, where the cooling gallery surface 60 is defined at least in part by an inner wall 62 of the piston crown 30 and an inner wall 64 of the piston skirt 32. Cooling gallery 44 may also include one or more fluid inlet apertures 70, and one or more fluid outlet apertures 72 to facilitate fluid flow through the gallery 44. However, it should be known that a cooling gallery 44 may or may not be present depending on the particular application.

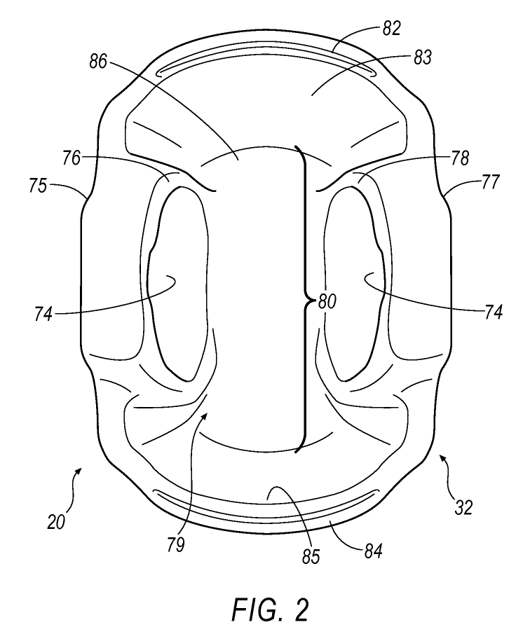

As shown in FIGS. 1 and 2, piston skirt 32 includes a pair of opposing wrist bores 74 through piston walls 75, 77 having inner surfaces 76, 78 for receiving a wrist pin (not shown) to rotatively connect the piston 20 to a connecting rod (not shown). Piston skirt 32 defines a generally cup-shaped interior space 79. Piston skirt 32 further includes a pair of opposing side walls 82, 84 having inner surfaces 83, 85 and top portions 86, 87 which are integral with an undercrown 80. Undercrown 80 is formed on the lower surface of the piston crown 30 and is generally cup-shaped. Undercrown 80 may be located beneath the highest portion of the piston 20.

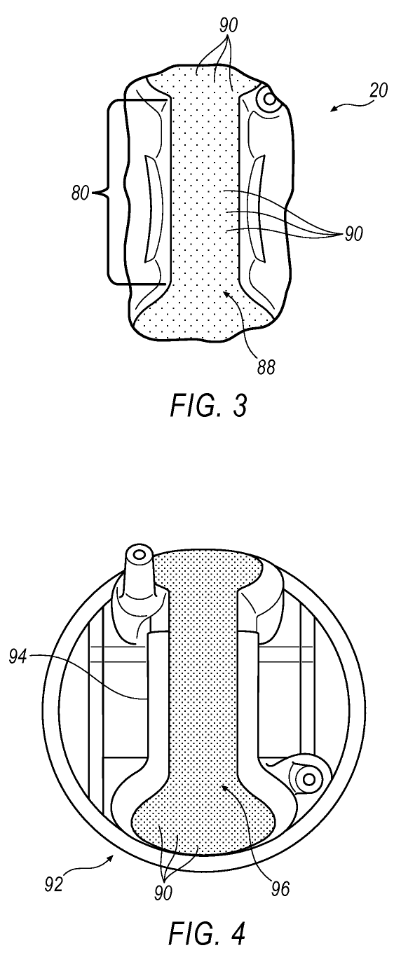

As shown in FIG. 3, undercrown 80 includes at least one region of increased surface area 88, in which the surface of undercrown 80 is rough. The roughness in the region of increased surface area 88 is created by a plurality of indentations 90. Indentations 90 may be formed in the undercrown 80 during the casting of piston 20, but in a manner intentionally increasing the roughness as compared to more traditional casting techniques where some degree of roughness exists merely by virtue of undertaking a casting. More specifically, indentations 90 may extend to a depth in the range of approximately 0.1 mm to 1.0 mm below the surface of undercrown 80. Tighter tolerances may be desirable under some circumstances. Thus, each indentation 90 increases the surface area of the undercrown 80.

In this manner, the indentations 90 form regions of increased surface area 88 in the undercrown 80. In some exemplary approaches the regions are contiguous, and in other approaches the regions are positioned only where more significant heat dissipation is necessary. The regions of increased surface area 88 of undercrown 80 improves the heat dissipation of piston 20 as the larger surface area allows for a greater amount of heat to be dissipated. As the piston 20 is repeatedly subjected to severe thermal stresses and temperatures during operation, such improvements to the heat dissipation of the piston 20 may enhance the performance of the piston 20. Forming the at least one region of increased surface area 88 in the undercrown 80 is generally useful since the undercrown 80 is located beneath the highest portion of the piston 20, which is also the hottest area of the piston 20 during operation of the piston 20. Thus, forming the at least one region of increased surface area 88 in the undercrown 80 has potentially the most significant impact on the heat dissipation of the piston 20.

Increasing the size of the regions of increased surface area 88 also increases the amount of heat that can be dissipated by piston 20. The regions of increased surface area 88 may encompass any portion of the undercrown 80 of the piston 20. Preferably, the regions of increased surface area 88 encompass as much of the surface of the undercrown 80 as the casting technology allows. Additionally, as shown in FIG. 2, the regions of increased surface area 88 may extend beyond the undercrown 80 and onto additional surfaces in the interior of the piston 20, including one or both of the inner surfaces 83, 85 of side walls 82, 84 of piston skirt 32.

As noted above, the regions of increased surface area 88 may be formed in the undercrown 80 during the casting of the piston 20. Piston 20 may be formed by traditional casting methods, such as, but not limited to, sand, lost foam, investment or die-casting methods. The casting methods may be altered to promote the number and increased depth of indentations 90. Merely by way of example, the piston 20 may be formed by die-casting in a mold including a first upper mold member (cope, not shown) and a second mold member (drag, not shown). The mold members may include a plurality of cores or casting tools 92, which create the near net shape of the piston 20 and regions of increased surface area 88, as shown in FIG. 4. Casting tool 92 includes a curved upper portion 94, which is used during the casting process to form the undercrown 80 and the generally cup-shaped interior space 79 defined by piston skirt 32.

The outer surface of the curved upper portion 94 of casting tool 92 may include a surface roughener 96. As shown in FIG. 4, the surface roughener 96 includes a plurality of casting indentations 90, which are formed into the curved upper portion 94 of casting tool 92. Casting indentations 90 may be engraved into the casting tool 92 by any suitable means, including, but not limited to spark erosion or grinding. The plurality of casting indentations 90 creates a roughened surface having peaks and valleys on the undercrown 80 of the piston 20 (shown in FIG. 3) by forming indentations 90 on the undercrown 80 corresponding to the casting indentations 90 during the casting process. These indentations 90 on the undercrown 80 form the regions of increased surface area 88. As the casting indentations 90 engraved into the casting tool 92 may have varying depths, the indentations 90 formed on the undercrown 80 may have corresponding varying depths. Thus, a pattern of indentations 90 of varying depths may be formed in the region of increased surface area 88 on the undercrown 80, as shown in FIG. 3.

The size of the regions of increased surface area 88 formed in the undercrown 80 is determined by the amount of surface area of the curved upper portion 94 of the casting tool 92 in which the casting indentations 90 are engraved. The greater the surface area of the curved upper portion 94 of the casting tool 92 in which the casting indentations 90 are formed, the greater the size of the regions of increased surface area 88 formed in the piston 20 during casting. Indeed, increasing the surface area of the curved upper portion 94 of the casting tool 92 in which casting indentations 90 are engraved can result in the regions of increased surface area 88, illustrated in FIGS. 2 and 3, being formed on other surfaces in addition to the undercrown 80, including the interior surfaces 83, 85 of the side walls 82, 84 of the piston skirt 32.

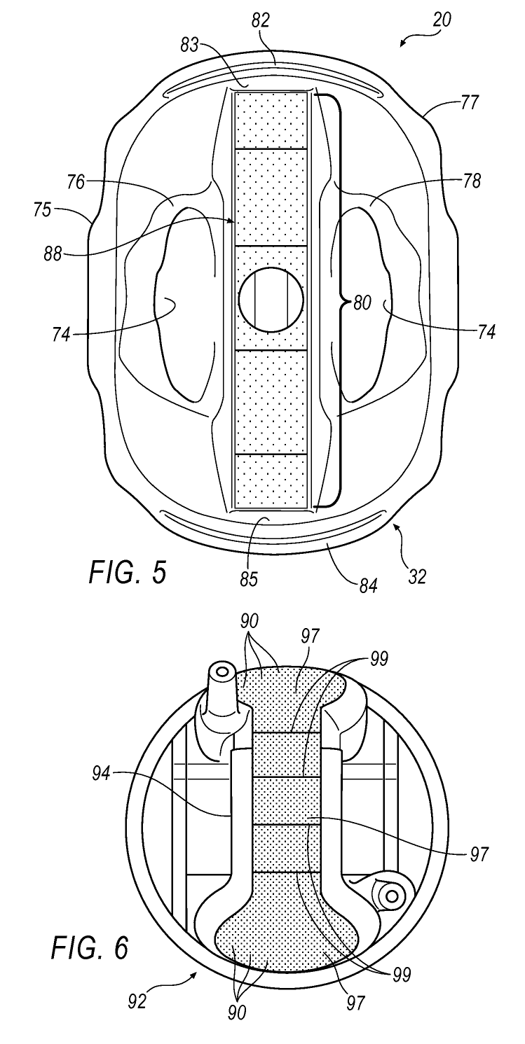

Additionally, as shown in FIG. 5 and noted above, more than one region of increased surface area 88 may be formed on undercrown 80 during casting. This may be accomplished by engraving casting indentations 90 in the curved upper portion 94 of the casting tool 92 in discrete surface roughener segments 97 that are separated from one another as shown in FIG. 6 by way of boundary lines 99. Each of the discrete surface roughener segments 97 will form a region of increased surface area 88 in the undercrown 80 of the piston 20 during casting.

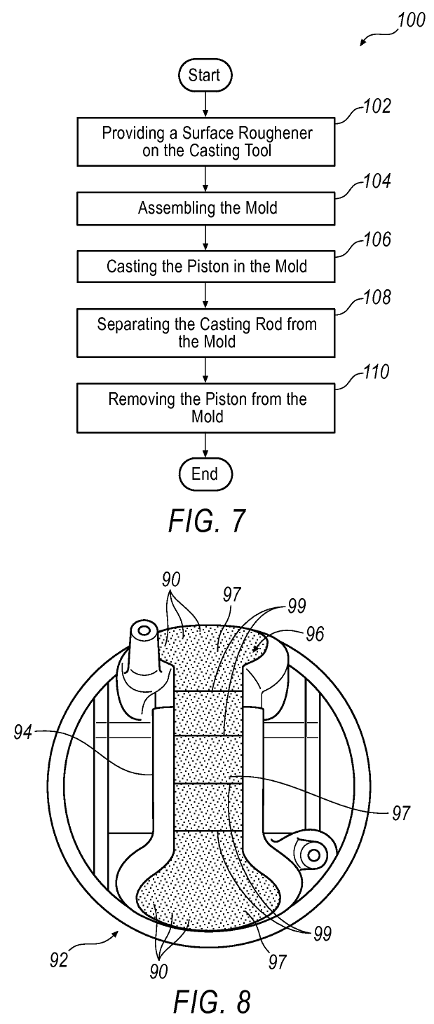

Turning now to FIG. 7, a process 100 for forming piston 20 is illustrated. Process 100 may begin at step 102, where a surface roughener 96 in the form of a plurality of casting indentations 90 are engraved into a casting tool 92. The casting indentations 90 may be engraved into any portion of the casting tool 92 that will allow for modification, such as, but not limited to the curved upper portion 94.

In step 104, the mold for casting the piston 20 is assembled, including the casting tool 92. The mold may include a plurality of casting tools (cores) 92 and may be positioned in a variety of ways. Merely by way of example, a five piece casting tool 92 may be used where there is at least a middle section that is inserted and removed first with exterior cores surrounding the middle section. It should be known that voids between the casting tools 92 create the final shape of the piston 20. In step 106, the piston 20 is cast in the mold by injecting or pouring molten metal through a gating system and into the voids surrounding the casting tools 92. The surface roughener 96 formed in the curved upper portion 94 of the casting tool 92 forms a corresponding rough surface in the undercrown 80 of the piston 20 during the casting process. This rough surface defines at least one region of increased surface area 88 which improves the heat dissipation properties of the piston 20. The casting tool 92 is then separated from the mold in step 108 by removing the middle casting tool first and the exterior casting tools 92 second. The piston 20 is then removed from the mold in step 110 and allowed to cool. Upon removal from the mold, the piston 20 may be allowed to cool naturally or may be submitted to a heat treating process, such as, but not limited to annealing, case hardening, precipitation strengthening, tempering and quenching. The heat treating may alter the physical or chemical properties of the materials used and may impart a particular hardness to the piston 20.

Alternatively, as shown in FIG. 8, the surface roughener 96 used to form the indentations 90 in the undercrown 80 may be a coating (not shown), such as, but not limited to ceramic or other heat resistant coating, which is applied to the curved upper portion 94 of the casting tool 92. When applied to the undercrown 80 of the piston 20, the coating may form at least a portion of a roughened surface on the undercrown 80 by forming the indentations 90 on the undercrown 80 during the casting process. These indentations 90 on the undercrown 80 form a region of increased surface area 88. Due to the nature of the coatings applied to the casting tool 92, the indentations 90 formed on the undercrown 80 may have varying depths. Thus, a random pattern of indentations 90 of varying depths may be formed in the regions of increased surface area 88.

As noted above, the surface roughener coating (not shown) applied to the curved upper portion 94 of the casting tool 92 will affect the surface characteristics of the undercrown 80 by creating a roughened surface of indentations 90 on the undercrown 80. A variety of coatings may be applied to the casting tool 92 to create the roughened surface on undercrown 80, including, but not limited to, a rough metallic coating, a ceramic coating and a black wash coating. The depth of the indentations 90 can be controlled by the selection of the specific coating to be applied to the curved upper portion 94 of the casting tool 92 and the thickness of the coating applied to the curved upper portion 94 of the casting tool 92.

Additionally, the size of the regions of increased surface area 88 may be determined by the amount of coating applied to the curved upper portion 94 of the casting tool 92. The greater the surface area of the coating applied to the curved upper portion 94, the greater the size of the region of increased surface area 88 formed on the undercrown 80 during casting. Indeed, increasing the surface area of the coating applied to the curved upper portion 94 may result in the region of increased surface area 88 being formed on other surfaces in addition to the undercrown 80, including the inner surfaces 83, 85 of the side walls 82, 84 of piston skirt 32.

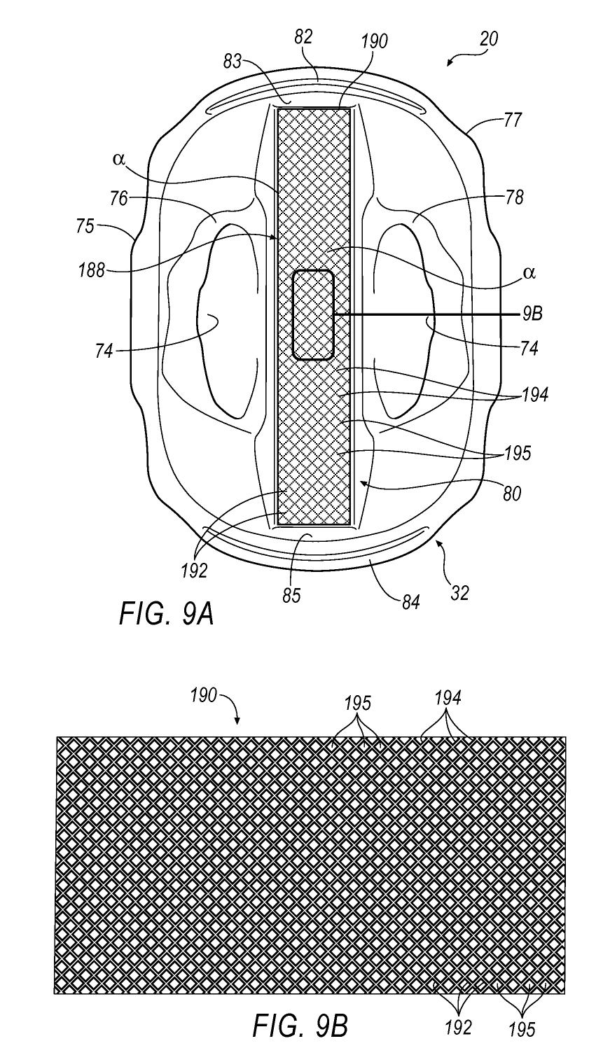

Turning now to FIG. 9A, an alternate illustration of the region of increased surface area 188 formed on the surface of undercrown 80 of the piston 20 is shown. Piston 20 includes an exemplary region of increased surface area 188 that is defined by a cross-hatching pattern 190 integrated onto the surface of the undercrown 80 of the piston during casting of the piston 20. A close-up view of cross-hatching 190 is shown in FIG. 9B. Cross-hatching 190 may include two groups of generally uniform, parallel ridges 192, 194 formed on the surface of the undercrown 80. Each group of the plurality of ridges 192, 194 intersect each other, forming a plurality of cavities 195 between the ridges 192, 194. Ridges 192, 194 may be formed at an angle α with respect to the horizontal axis A of the piston 20. Preferably, the angle α of the ridges 192, 194 is approximately 45 degrees. Providing the ridges 192, 194 at such an angle α with respect to the horizontal axis A creates a uniform square-shaped waffle-like pattern on the surface of the undercrown 80 containing a plurality of generally diamond shaped cavities 195. Angling the ridges 192, 194 with respect to the horizontal axis A permits the length of the ridges 192, 194 to be longer than the width of the cross-hatching 190. The ends of ridges 192, 194 at the edges of cross-hatching 190 may taper to the surface of the undercrown 80.

The distance between adjacent ridges 192 and adjacent ridges 194 may be in the range of approximately 0.5 mm to 1.0 mm, and the ridges 192, 194 may have a height from the surface of the undercrown 80 in the range of approximately 0.4 mm to 1.0 mm. Tighter tolerances may be desirable under some circumstances. Reducing the distance between adjacent ridges 192, 194 allows for a greater number of ridges 192, 194 to be formed on the undercrown 80. Maximizing the number of ridges 192, 194 on the surface of the undercrown 80, and the height and width of the ridges 192, 194, maximizes the amount of surface area that is created in the region of increased surface area 188 on undercrown 80. Depending on the environment of use, it may be desirable to increase the surface area as much as possible as the larger surface area allows for greater heat dissipation by the piston 20, while still taking into account the dynamic and static force requirements of the load bearing surface between the wrist pin and its mating piston surface.

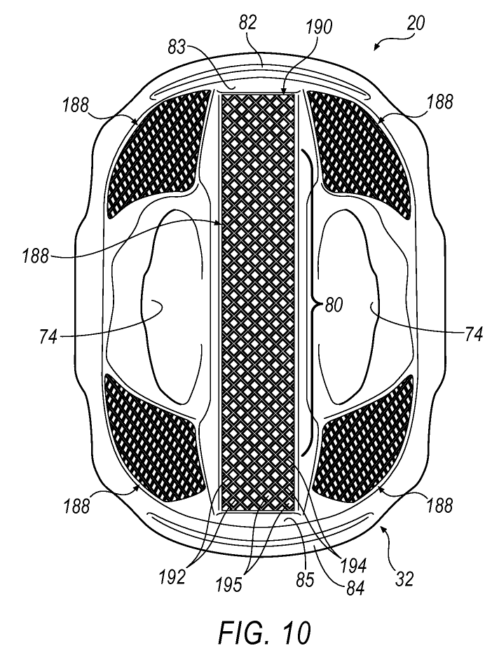

The exemplary region of increased surface area 188 defined by the cross-hatching 190 may be formed on a substantial portion of the surface of the undercrown 80. Preferably, the cross-hatching 190 is formed on a minimum of approximately forty percent (40%) of the surface of the undercrown 80. Additionally, as shown in FIG. 10, the cross-hatching 190 may extend beyond the undercrown 80 and onto additional surfaces in the interior of the piston 20, forming additional regions of increased surface area 188, including one or both of the inner surfaces 83, 85 of side walls 82, 84 of piston skirt 32, and/or onto one or both of the inner surfaces 76, 78 of the piston walls 75, 77 of the piston skirt 32.

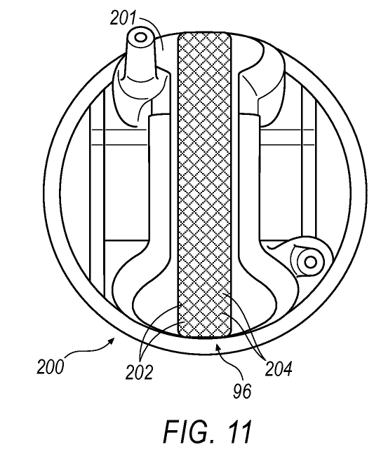

Turning now to FIG. 11, an illustration of the casting tool 200 is shown which forms the cross-hatching 190 on the surface of the undercrown 80 of the piston 20 during the casting process. Alternatively, a machining operation may be undertaken once the casting is completed. When cast, however, the surface roughener 96 of the casting tool 200 includes a plurality of grooves 202, 204 which are formed into the surface of the curved upper portion 201 of casting tool 200. Grooves 202, 204 may be formed into the surface of the curved upper portion 201 of casting tool 200 by any suitable means, including, but not limited to, spark erosion or a milling operation. The plurality of grooves 202, 204 creates a roughened surface on the surface of the undercrown 80 by forming ridges 192, 194 on the surface of the undercrown 80 corresponding to the grooves 202, 204 during the casting process. The ridges 192, 194 on the surface of the undercrown 80 form the cross-hatching 190 which defines the region of increased surface area 188.

Alternatively, the cross-hatching pattern formed on the surface of the undercrown may include a plurality of generally uniform, parallel grooves formed into the surface of the undercrown. To form such grooves in the surface of the undercrown, the casting tool includes a plurality of generally uniform, parallel ridges formed onto the curved upper portion of the casting tool.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A piston for an internal combustion engine comprising:
a piston crown having an upper surface and a lower surface;
a piston skirt including a pair of opposite side walls having top portions and inner surfaces, the piston skirt formed on the lower surface of the piston crown; and
a generally cup-shaped undercrown formed on the lower surface of the piston crown and integral with the top portions of the opposing side walls of the piston skirt, at least a portion of the surface of the undercrown being rough, defining at least one region of increased surface area, wherein the distance between the uppermost and lowermost points of the surface of the undercrown in the at least one region of increased surface area is in the range of approximately 0.1 mm to 1.0 mm.

2. The piston according to claim 1, wherein the region of increased surface area includes a plurality of indentations formed in the surface of the undercrown.

3. The piston according to claim 2, wherein the plurality of indentations extend to a depth below the surface of the undercrown in the range of approximately 0.1 mm to 1.0 mm.

4. The piston according to claim 1, wherein the piston is formed by a casting process, and the plurality of indentations in the surface of the undercrown are formed during the casting process by a casting tool having at least a partially curved upper portion formed to engage and assist in defining the undercrown, the upper portion of the casting tool including a surface roughener.

5. The piston according to claim 4, wherein the surface roughener includes a plurality of casting indentations formed into the curved upper portion of the casting tool.

6. The piston according to claim 4, wherein the surface roughener includes a coating applied to the curved upper portion of the casting tool.

7. The piston according to claim 1, wherein the at least one region of increased surface area is also formed on the inner surface of at least one of the side walls.

8. The piston according to claim 1, wherein the region of increased surface area includes a plurality of generally parallel ridges extending from the surface of the undercrown, the plurality of ridges formed a cross-hatching pattern.

9. The piston according to claim 8, wherein adjacent ridges in the cross-hatching on the surface of the undercrown are separated by a distance in the range of approximately 0.5 mm to 1.0 mm.

10. The piston according to claim 8, wherein the plurality of ridges have a height from the surface of the undercrown in the range of approximately 0.4 mm to 1.0 mm.

11. The piston according to claim 8, wherein the plurality of ridges are formed on the surface of the undercrown at an angle α to the horizontal axis of the piston.

12. The piston according to claim 11, wherein the angle α is approximately 45°.

13. The piston according to claim 1, wherein the at least one region of increased surface area is also formed on the inner surface of at least one of the side walls.

14. The piston according to claim 1, where the piston is formed by a casting process, and the plurality of indentations in the surface of the undercrown are formed during the casting process by a casting tool having at least a partially curved upper portion, the upper portion of the casting tool including a surface roughener.

15. The piston according to claim 14, wherein the surface roughener includes a plurality of grooves formed into the curved upper portion of the casting tool.

16. The piston according to claims 14, wherein the surface roughener is formed in the casting tool using at least one of spark erosion, grinding, milling and casting.
